(19) United States
(12) Patent Application Publication
(10) Pub. No.: US 2021/0330545 A1
(43) Pub. Date: Oct. 28, 2021

(54) FEMALE STIMULATION DEVICE

(71) Applicant: CRISWELL WOODLIFF, Salt Lake City, UT (US)

(72) Inventor: CRISWELL WOODLIFF, Salt Lake City, UT (US)

(21) Appl. No.: 16/856,932

(22) Filed: Apr. 23, 2020

(51) Int. Cl. A61H 19/00; A61H 23/00; A61H 23/02

(52) U.S. Cl. CPC A61H 19/30; A61H 19/50; A61H 23/004; A61H 23/0254; A61H 2205/087; A61H 2201/5007; A61H 2201/5097; A61H 2201/5023; A61H 2201/169; A61H 2201/0153

(57) ABSTRACT

A female stimulation device includes a head portion and a handle portion connected to and extending from the head portion. The head portion includes a suction surface and a suction chamber positioned on the suction surface. The stimulation device also includes a suction motor connected to the suction chamber and a plurality of vibration motors adjacent to and connected to the suction chamber.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

### 1. The Field of the Present Disclosure

The present invention relates to the field of sexual paraphernalia. In particular, the present invention provides an electro-mechanical device for sexual stimulation intended for use by women either as an auto-erotic aid or during intercourse.

### 2. Description of Related Art

There are numerous devices available for use by women for sexual stimulation. They include products that are entirely manually operated, and achieve stimulation by shape and/or texture, and products that are provided with internal motors that achieve stimulation by shape, texture and vibration. These latter devices, commonly referred to as vibrators, are usually phallus shaped, and are provided with a handle for manipulation in and around the genital region by a woman.

The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims. Any discussion of documents, acts, materials, devices, articles or the like which has been included in the present specification is not to be taken as an admission that any or all of these matters form part of the prior art base, or were common general knowledge in the field relevant to the present disclosure as it existed before the priority date of each claim of this application.

### BRIEF DESCRIPTION OF THE DRAWINGS

The features and advantages of the disclosure will become apparent from a consideration of the subsequent detailed description presented in connection with the accompanying drawings in which:

FIG. 1 is a top view of a female stimulation device in accordance with the principles of the present disclosure;

FIG. 2 is a side view, of the female stimulation device of FIG. 1;

FIG. 3 is a partial cutaway top view, of the female stimulation device of FIG. 1;

FIG. 4 is a partial cutaway side view, of the female stimulation device of FIG. 1;

FIG. 5 is a partial cutaway top view, of the handle of the female stimulation device of FIG. 1;

FIG. 6 is a mask embodiment according to the present disclosure;

FIG. 7 is another mask embodiment according to the present disclosure;

FIG. 8 is a further mask embodiment according to the present disclosure;

FIG. 9 is an attachment embodiment according to the present disclosure;

FIG. 10 is an alternative handle embodiment according to the present disclosure;

FIG. 11 is another embodiment of the present disclosure having an oscillating film, shown in a neutral position; further mask embodiment according to the present disclosure;

FIG. 12 is the embodiment of FIG. 11 with the oscillating film an an expanded position; and

FIG. 13 is the embodiment of FIG. 11 with the oscillating film in a retracted position.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure from the subject matter disclosed in the reference materials.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

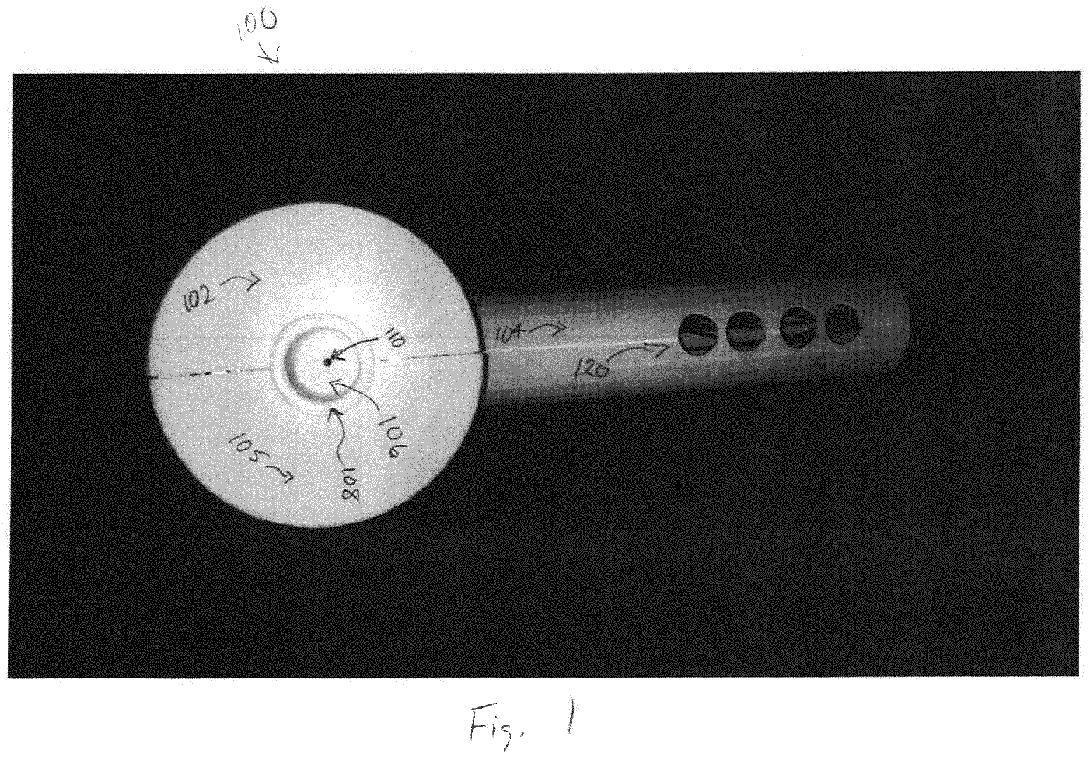

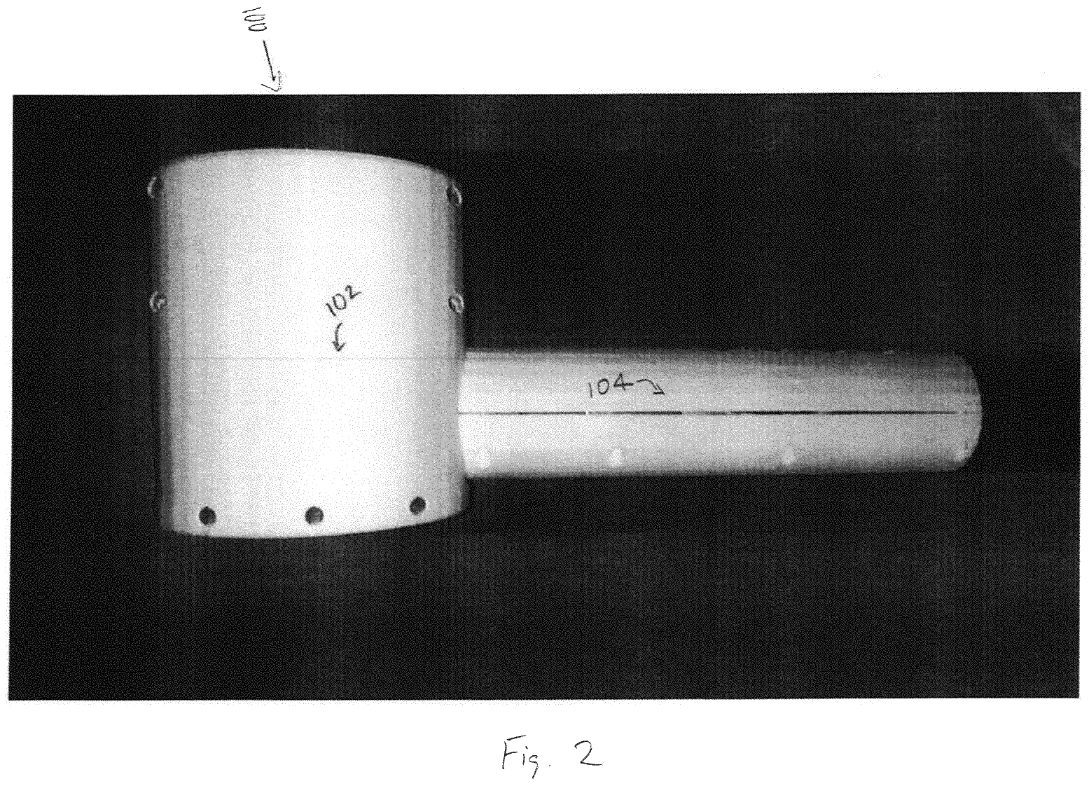

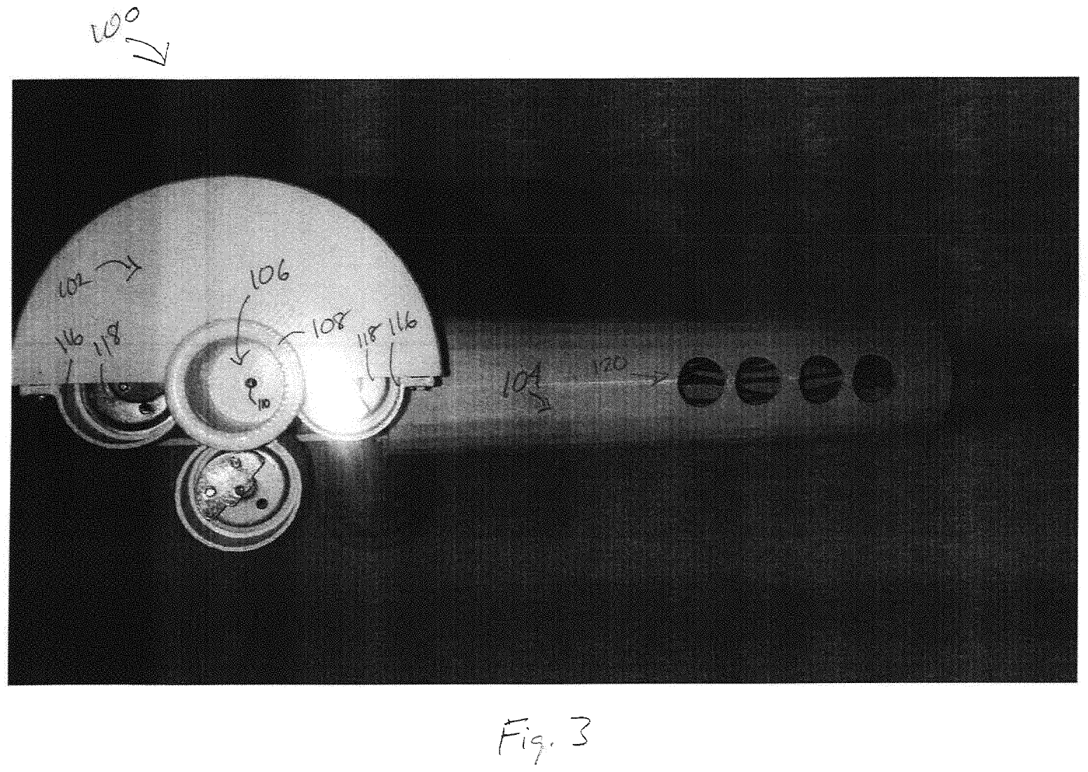

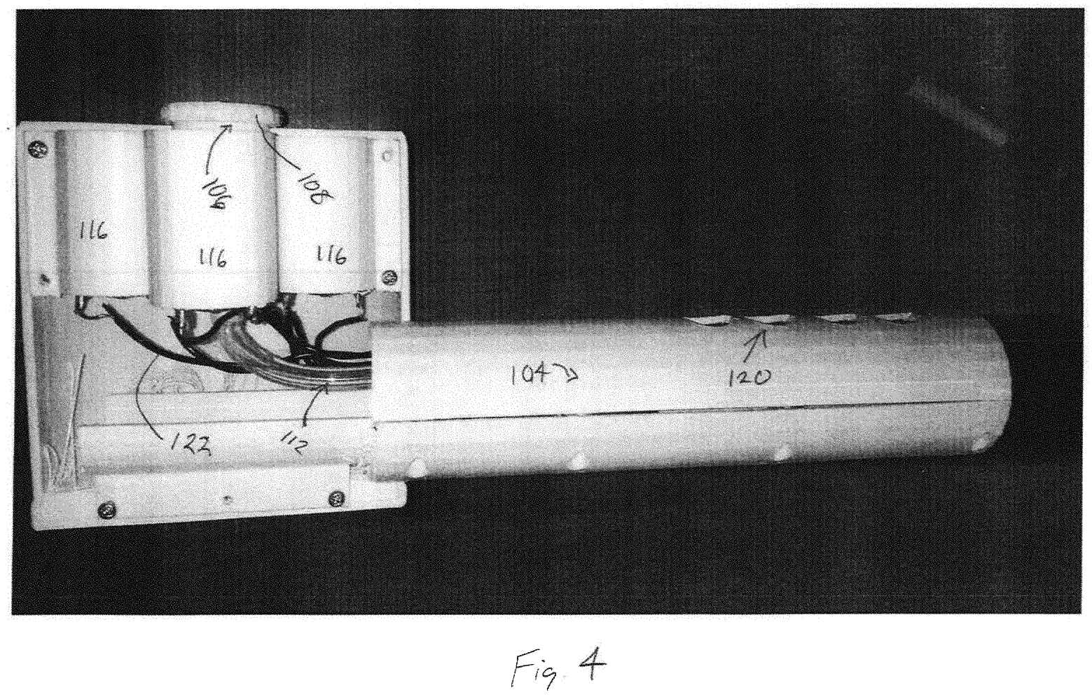

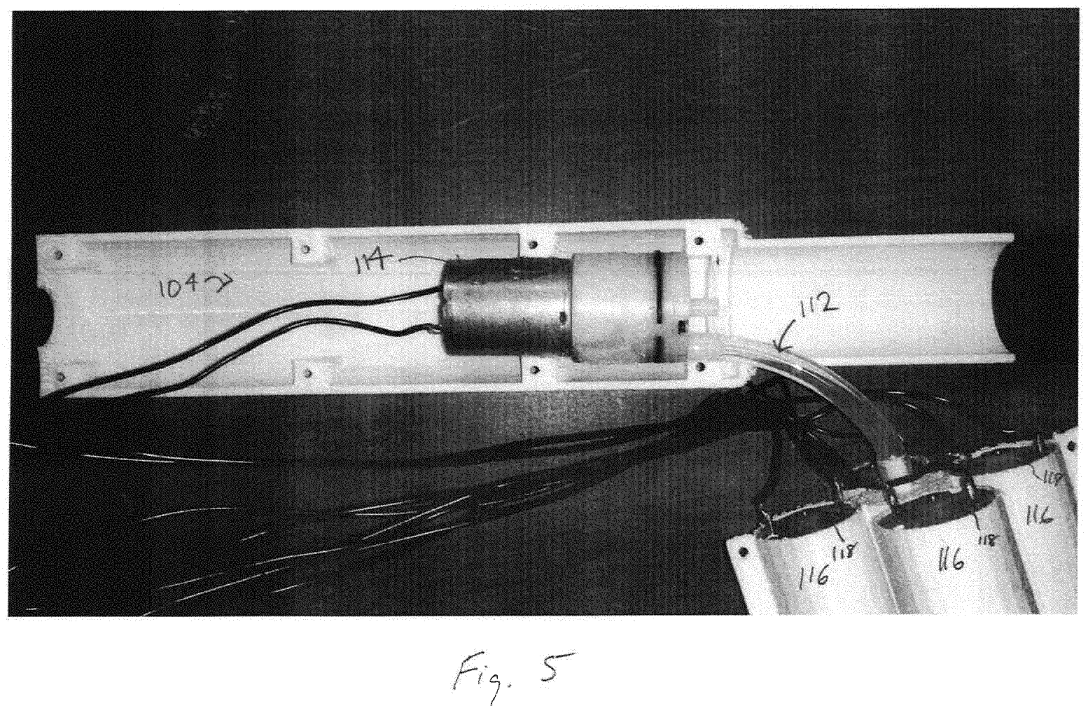

Referring now to FIGS. 1-5, a disclosed female stimulation device 100 may include a head 102 and a handle 104. The head 102 may be connected or engaged with the handle 104 such that the handle 104 may be used to control and/or manipulate the position or movement of the head 102. The head 102 may be releasably engaged with the handle 104 or permanently fixed thereto. In another example, head 102 may be formed or fabricated as a single unitary piece with the handle 104, fully integrating the head 102 and handle 104 together. The head 102 and the handle 104 may be fabrication from plastic, ABS, wood, metal, rubber, or any other material that may be nonporous and smooth.

The head 102 may have a substantially cylindrical shape, as shown in FIG. 1, or alternatively, the head 102 may be formed having any desired shape. The head 102 may also include a planar or substantially planar suction surface 105. In alternative embodiments, the suction surface may not be planar and may instead be concave, convex, or have alternative desired contours.

The suction surface 105 may include a suction chamber 106. The suction chamber 106 may be formed in the center of the suction surface 105, or at another desired location on the suction surface 105. The suction chamber 106 may be formed in a substantially cylindrical shape, however, the suction chamber 106 may alternatively be formed in any desired shape or size.

The suction chamber 106 may include a lip 108 that extends around an exterior rim of the suction chamber 106. The lip 108 may be made of a softer more pliable material than the suction chamber 106 and head 102. The lip 108 may be provided as a removable feature of the suction chamber 106 which may enable a user to replace the lip 106, if damaged or worn, or alternatively, the lip 108 may be made in varying shapes, sizes and materials, enabling a user to customize the lip 108 according to a desired preference.

The suction chamber 106 may also include a opening 110 that provides access to a suction tube 112. The suction tube 112 may extend from the opening 110 of the suction chamber 106 through an interior cavity of the head 102 and through an interior cavity in the handle 104. Inside the interior cavity in the handle 104, a suction or vacuum motor 114 may fixed or mounted to an interior surface of the handle 104.

The suction tube 112 may be operationally secured to the suction motor 114, enabling the suction motor 114 to suck air out of the suction chamber 106, thereby providing a suction force against any object, such as desired body parts of a user, adjacent to the lip 108 of the suction chamber 106.

The head 102 may also include a plurality of vibration chambers 116. The stimulation device 100 may include four vibration chambers 116 as shown in the figures, but may alternatively include more or less vibration chambers 116. In the disclosed embodiment the vibration chambers 116 may be positioned around the suction chamber 106 equidistant from adjacent vibration chambers 116, thus forming a cross formation.

Each of the vibration chambers 116 may include a vibration motor 118. Each of the vibration motors 118 may be designed and configured to vibrate the corresponding vibration chambers 116. As the vibration chambers 116 vibrate, the vibrations with be transferred to the suction chamber 106 causing the suction chamber 106 and lip 108 to also vibrate. The vibration chambers 116 and other components and elements of the stimulation device 100 may be formed from acrylic or any other desired material, including the materials used for the head 102 and handle 104.

Each of the vibration motors 118 may be electronically controlled by the user via a control panel 120. The control panel 120 may include a plurality of buttons that may be used to operate the vibrations motors, both individually and in combination with one another. Accordingly, each of the vibration motors 118 may be electrically connected to the control panel 120 via corresponding wires 122.

Additionally, each of the vibration motors 118 and the suction motor 114 may be brushless which improves durability and power. The suction motor may also be characterized as a micro air pump, for example. And the vibration motors 118 may, for example, be coin-type motors.

The control panel 120 can enable a user to also operate the suction motor 114, enabling a user to independently operate the suction feature of the stimulation device 100. Alternatively the vibration motors 118 and the suction motor 114 may be programmed and operated by a preprogrammed microchip or operating system that may provide a plurality of vibration patterns and intervals and suction patterns and intervals by intermittently operating corresponding vibrations motors 118 and the suction motor 114. In another alternative embodiment, the stimulation device 100 may be operated by a remote control, mobile application, or other computer software independent from the control panel 120. The control panel 120 or any other control device, may be configured to control the tempo, alteration, speed and power of each of the vibration motors 118 and the suction motor 114

In a still further embodiment, the stimulation device 100 may receive power from an electrical outlet via a hardwired plug, or alternatively may include batteries which may provide power to each of the suction motor 114 and the vibration motors 118.

In another embodiment, as shown in FIG. 6, the above described stimulation device 100 may alternatively include a silicone or rubber mask 200 that may cover the lip 108 and interior of the suction chamber 106.

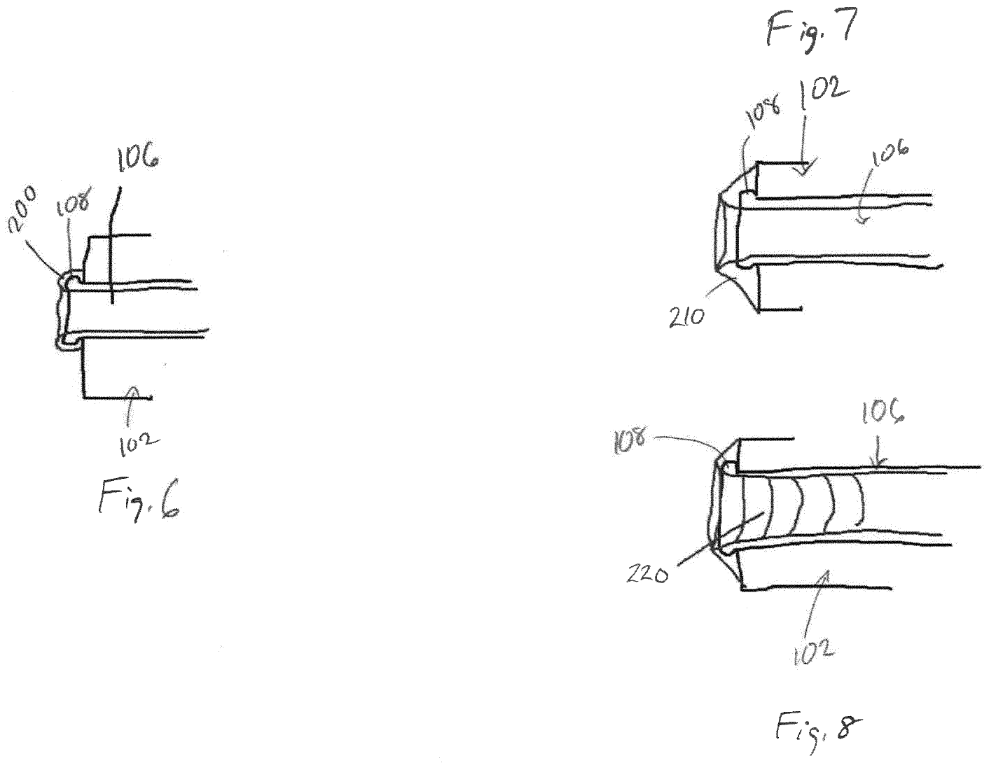

In another embodiment, as shown in FIG. 7, the above described stimulation device 100 may alternatively include a mask 210 that may extend a greater distance over the lip 108 than mask 200, but may also be made of silicone, plastic or other similar material.

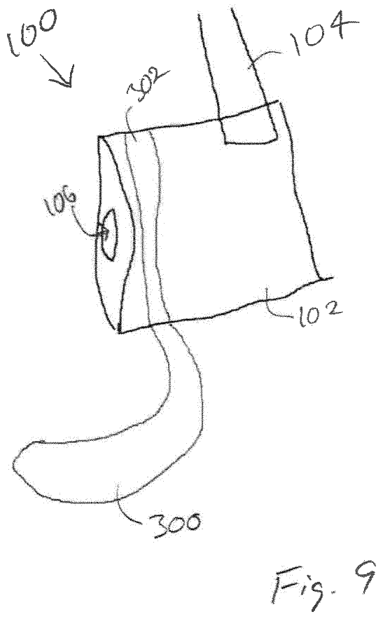

In another embodiment, as shown in FIG. 8, the above described stimulation device 100 may alternatively include a mask 220 that may extend a greater distance over the lip 108 than mask 200 and may also include a plurality of ribs that may extend with the suction chamber 106. Alternatively, mask 220 may include bumps, ridges or other desired texturing. Mask 220 may also be made of silicone, plastic or other similar material.

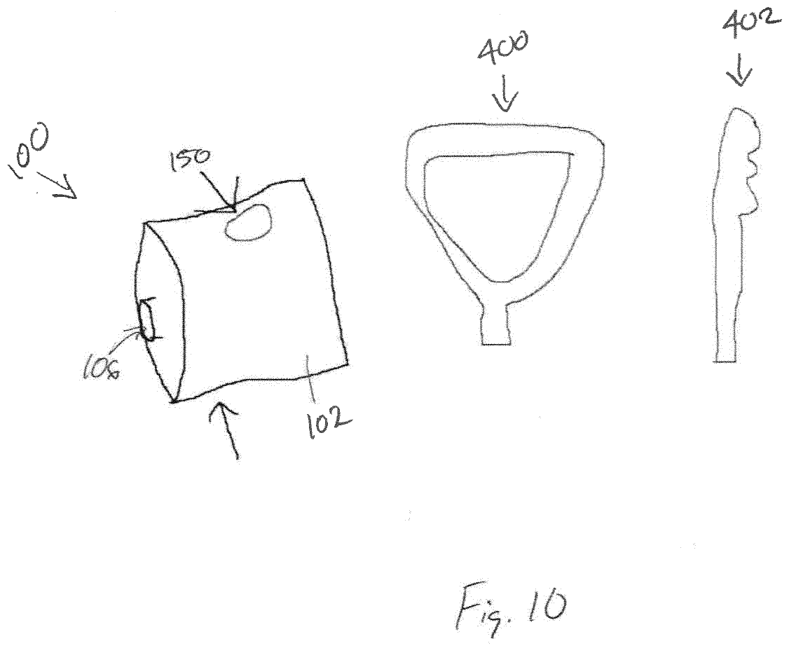

In another exemplary embodiment as shown in FIG. 9, the stimulation device 100 may include a phallic attachment 300 which can be secured to the head 102 by a band 302 or strap, that may be attached to an exterior of the head 102. The phallic attachment may extend toward the user during operation and may be made of silicone, plastic or other similar material. The phallic attachment 300 may also include an independent motor or motors that can manipulate movement and/or vibration of the attachment 300. Additionally, the attachment may be formed in any desired shape or size.

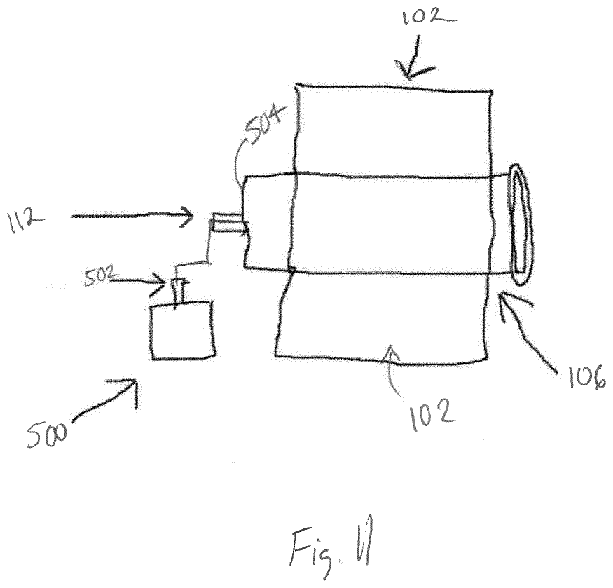

In another exemplary embodiment as shown in FIG. 10, the head 102 may be detached from handle 104 and may instead include an alternative handle 400. The handle 400 may include a looped portion for improved handling of the stimulation device 100. The handle 400 may be secured to head 102 at an attachment recess 150, which may accommodate a variety of alternative handles. For example, alternative handle 402 may also be releasably connected to head 102 at the attachment recess, enabling a user to user various alternative handles. Handle 402 may be substantially straight and include a grip portion on a terminating end of the handle 402, providing better handling and manipulation of the head 102.

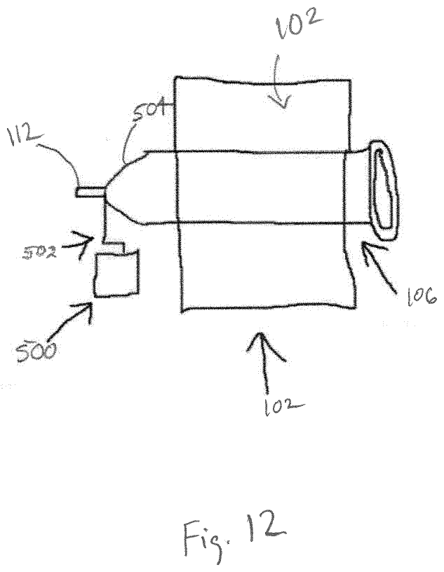

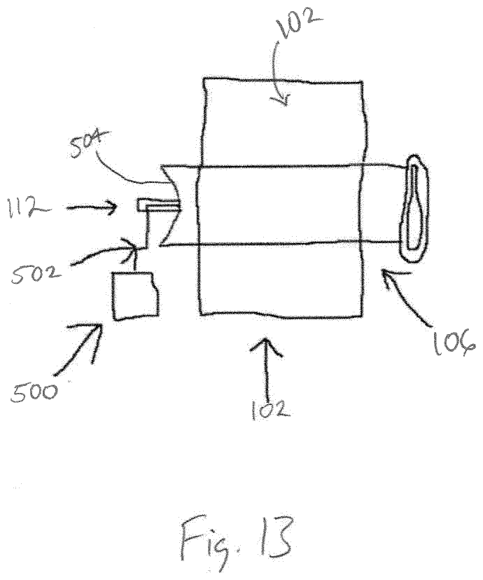

Referring now to FIGS. 11-13, in another embodiment of a disclosed female stimulation device may, the stimulation device may include the same, or substantially similar head 102, as disclosed in other embodiment above, including corresponding vibration chambers and the suction chamber 106. Additionally, as described in more detail above, the suction chamber 106 may be connected to the suction tube 112 which may extend from the opening 110 (not shown in FIGS. 11-13) of the suction chamber 106 through an interior cavity of the head 102 and through an interior cavity in the handle 104. Inside the interior cavity in the handle 104, a suction or vacuum motor 114 may fixed or mounted to an interior surface of the handle 104.

The suction tube 112 may be operationally secured to the suction motor 114 (although FIGS. 11-13 show a cut-away view of the suction tube 112, so the connection with the suction motor is not shown), enabling the suction motor 114 to suck air out of the suction chamber 106, thereby providing a suction force against any object, such as desired body parts of a user, adjacent to the lip 108 of the suction chamber 106.

The head 102 may also include a motor 500, operationally connected to a drive shaft 502. The motor 500 can be of any desired type, including, but not limited to, a rotary motor, oscillating motor, vibration motor, or piston motor.

The drive shaft 502 may be connected to flexible film or membrane 504 that substantially covers a proximal end of the suction chamber 106. The film 504 may be made of plastic, rubber or any other desired, flexible material. The rotation of the drive shaft 502 by the motor 500 causes the film 504 to oscillate in and out of the suction chamber 106, thereby causing a change in the internal pressure within the suction chamber 106, from positive to negative. This change in pressure can result in a perceptible pressure pulse, that me be felt by a user during use.

The suction tube 112 may me connected to the film 504, as shown in FIGS. 11-13, or alternatively, the suction tube 112 may be connected to the suction chamber at an intermediate location within the suction chamber 112.

In yet another embodiment, the stimulation device may include the motor 500 and film 504, but not include the suction tube 112 or corresponding suction motor, thereby relying on the oscillation of the film 504 to generate any pressure change in the suction chamber 106.

The motor 500 may be programmed to operate synergistically with the other vibration motors and suction motor described above. Alternatively, the motor 500 may be operated independently of any other motor in the stimulation device 100.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A stimulation device, comprising:
a head portion;
a handle portion connected to and extending from the head portion;
the head portion having suction surface and a suction chamber positioned on the suction surface;
a suction motor connected to the suction chamber; and
a plurality of vibration motors adjacent to the suction chamber.

2. The stimulation device of claim 1, wherein the plurality of vibration motors include four vibration motors.

3. The stimulation device of claim 1, further comprising:
a plurality of vibration chambers, wherein at least one of each of the plurality of vibrations motors is positioned in each of the plurality of vibration chambers.

4. The stimulation device of claim 1, further comprising:
a control panel positioned on the handle and configured to independently control each of the plurality of vibration motors and the suction motor.

5. The stimulation device of claim 1, wherein the suction chamber includes a lip that extends around on opening of the suction chamber.

6. The stimulation device of claim 5, wherein the lip is formed of a different material than the head.

7. The stimulation device of claim 5, further comprising:
a mask removeably connected to the lip, wherein the mask covers the lip.

8. The stimulation device of claim 7, wherein at least a portion of the mask includes ridges.

9. The stimulation device of claim 1, wherein the plurality of vibration motors and the suction motor are configured to be operable by a preprogrammed microchip.

10. The stimulation device of claim 1, wherein the plurality of vibration motors and the suction motor are configured to be operable by a remote control device.

11. A stimulation device, comprising:
a head portion;
a handle portion integral with and extending from the head portion;
the head portion having suction surface and a suction chamber positioned on the suction surface;
a suction motor connected to the suction chamber via a suction tube; and
four vibration motors connected to the suction chamber.

12. The stimulation device of claim 11, wherein the vibration motors are powered by a battery.

13. The stimulation device of claim 11, further comprising:
four vibration chambers, wherein at least one of the four vibrations motors are positioned in each of the four of vibration chambers.

14. The stimulation device of claim 1, further comprising:
a control panel positioned on the handle and configured to independently control each of the vibration motors and the suction motor.

15. The stimulation device of claim 1, wherein the suction chamber includes a lip that extends around on opening of the suction chamber.

16. The stimulation device of claim 5, wherein the lip is formed of a different material than the head.

17. The stimulation device of claim 5, further comprising:
a mask removeably connected to the lip, wherein the mask covers the lip.

18. The stimulation device of claim 7, wherein at least a portion of the mask includes ridges.

19. The stimulation device of claim 1, wherein the vibration motors and the suction motor are configured to be operable by a preprogrammed microchip.

20. The stimulation device of claim 1, wherein the vibration motors and the suction motor are configured to be operable by a remote control device.

21. The stimulation device of claim 1, further comprising:
a flexible film substantially enclosing an open end of the suction chamber, wherein movement of the flexible film alters the air pressure within the suction chamber.

22. The stimulation device of claim 21, further comprising:
a motor operably connected to the flexible film, wherein the motor causes the film to oscillate in and out of the suction chamber.

23. The stimulation device of claim 11, further comprising:
a flexible film substantially enclosing an open end of the suction chamber, wherein movement of the flexible film alters the air pressure within the suction chamber.

24. The stimulation device of claim 21, further comprising:
a motor operably connected to the flexible film, wherein the motor causes the film to oscillate in and out of the suction chamber.
